(19) United States
(12) Patent Application Publication
(10) Pub. No.: US 2007/0021190 A1
(43) Pub. Date: Jan. 25, 2007

(54) Gaming machine

(75) Inventor: Masatsugu Kobayashi, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP

(21) Appl. No.: 11/489,591

(22) Filed: Jul. 20, 2006

(30) Foreign Application Priority Data
Jul. 25, 2005 (JP) 2005-213942

(51) Int. Cl. A63F 13/00

(52) U.S. Cl. 463/20

(57) ABSTRACT

After electric power of the slot machine is turned on, if the score of credit occurs, rotation of all reels 220 is started on the front panel 4 and various symbols are variably displayed in each of the variable display portions 22 to 24 while being scrolled from the upper direction toward the lower direction. Thereafter, if press operation of the stop buttons 27 to 29 is conducted, the reel corresponding to the stop button pressed is stopped to rotate, thereby three symbols are stopped and displayed in each of the variable display portions 22 to 24. And if the score of credit still exists when three symbols are stopped and displayed in each of the variable display portions 22 to 24, various symbols are again variably displayed in each of the variable display portions 22 to 24 from the upper direction toward the lower direction.

### CROSS-REFERENCE TO THE RELATED APPLICATIONS(S)

This application is based upon and claims a priority from the prior Japanese Patent Application No. 2005-213942 filed on Jul. 25, 2005, the entire contents of which are incorporated herein by reference.

### BACKGROUND OF THE INVENTION

1. Field of the Invention

The present invention relates to a gaming machine in which variable display and stop display of symbols is conducted on a display device.

2. Description of Related Art

In a conventional gaming machine, for example, a slot machine mainly exported for foreign countries, when a player presses a spin button, a lottery is conducted and reels start to rotate, and after a predetermined time elapses, the reels are automatically stopped and symbols are stopped and displayed on the reels corresponding to a lottery result. Thereby, a base game is progressed.

At that time, some of players feel that a time for conducting a game from rotation start of the reels to automatic stop thereof is long.

Thus, in order that players do not lose interest by reducing a time for a game, it is proposed in Unexamined Japanese Publication No. 2004-267648 a gaming machine that automatic rotation and stop of the reels, which are conducted over a plural times in a free game executed if a predetermined condition is realized after the reels are automatically stopped in a base game, are skipped, thereby a speedy payout is given to a player.

However, even if automatic rotation and stop of the reels are skipped, it concludes that a time for a free game is merely reduced and a time for a base game which almost occupies a total gaming time cannot be reduced.

### SUMMARY OF THE INVENTION

In order to dissolve the above problems, the present invention has been done and has an object to provide a gaming machine in which a gaming time can be reduced in a game that a payout is given to a player based on a stop display function of symbols determined by a result of lottery conducted by using a player's instruction as a trigger.

In order to accomplish the above object, according to one aspect of the present invention, it is provided a gaming machine comprising:

a display device for variable displaying a plurality of symbols;

an operation device for allowing a player to input an instruction;

a processor programmed to operate with the display device and the operation device to (a) automatically start a variable display of the symbols on the display device after a game is terminated, (b) enable the player to input the instruction by the operation device during the variable display of the symbols, (c) determine the symbols for a stop display on the display device based on the instruction, and (d) display the symbols determined on the display device.

According to the gaming machine of the present invention, after the game is started, the processor determines the symbols for a stop display on the display device based on the instruction while the variable display of the symbols is conducted on the display device, thereby the stop display of the symbols is done on the basis of the symbols determined by the processor. Further, the payout is done according to the symbols, and the game is terminated. Thereafter, the variable display of the symbols is automatically started by the processor, thus when a new game is started, the symbols are variably displayed on the display device. Therefore, concerning with the game that the payout is given based on the symbols determined by the processor based on the instruction output from the operation device, a gaming time can be reduced.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a schematic view showing an outline of a slot machine according to the present invention,

FIG. 2 is a perspective view of the slot machine,

FIG. 3 is a block diagram schematically showing a control system of the slot machine,

FIG. 4 is a block diagram of a liquid crystal drive circuit of a liquid crystal display,

FIG. 5 is an explanatory view to explain symbol columns each of which is formed on a peripheral surface of each reel and is variably displayed and stopped while scrolling in each of variable display portions,

FIG. 6 is an explanatory view showing a lottery table of stop display symbols,

FIG. 7 is an explanatory view showing winning combinations and payouts thereof,

FIG. 8 is a flowchart of a main process program,

FIG. 9 is a flowchart of a lottery and stop control process program,

FIG. 10 is an explanatory view showing a display state of three variable display portions in which three reels are rotating,

FIG. 11 is an explanatory view showing a display state of three variable display portions in which three reels are stopped,

FIG. 12 is another flowchart of the main process program, and

FIG. 13 is an explanatory view showing another lottery table of winning combinations and payouts thereof.

### DETAILED DESCRIPTION OF THE PREFERRED EMBODIMENTS

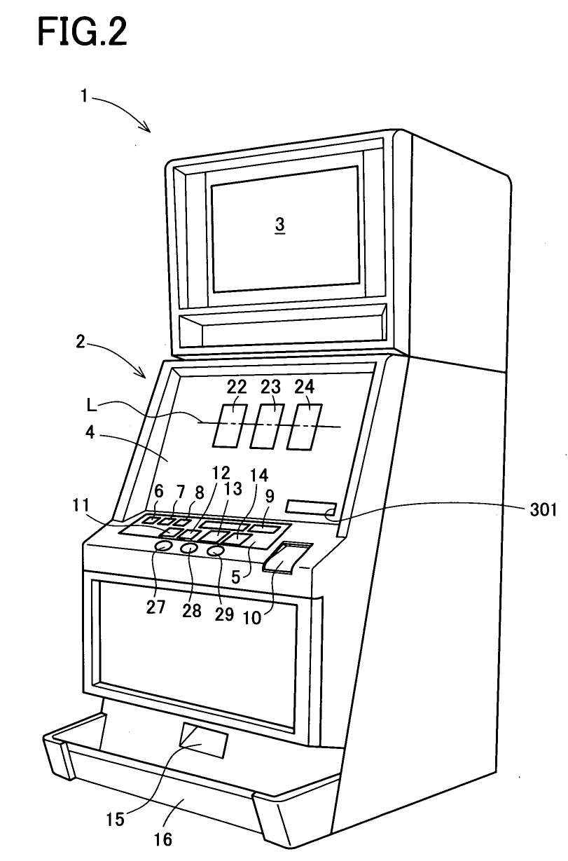

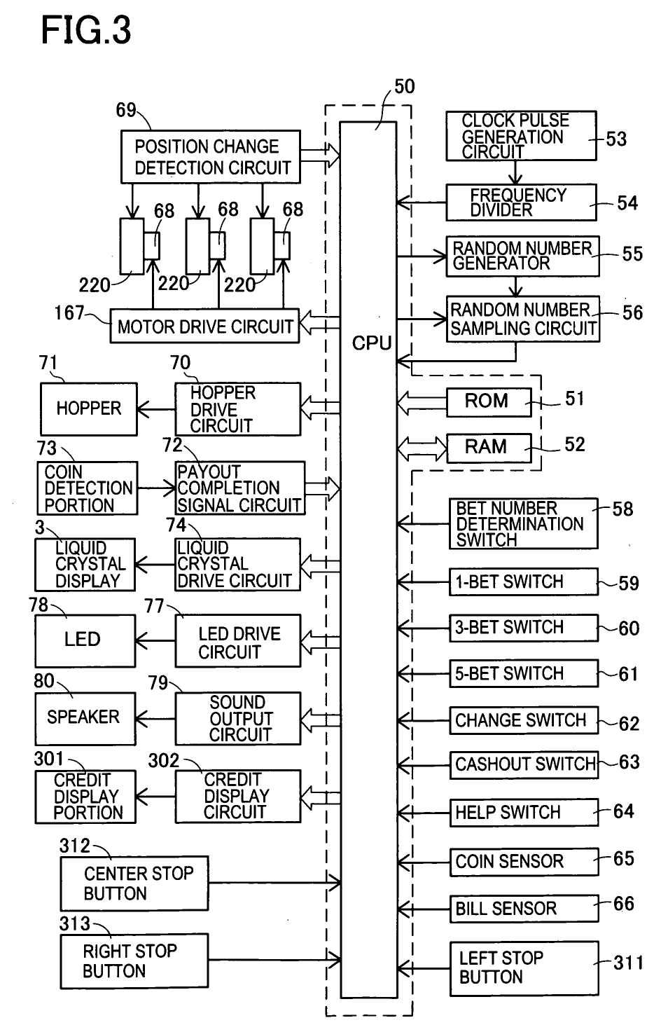

Hereinafter, a gaming machine according to the present invention will be described in detail with reference to the drawings based on the embodiment embodying the present invention in a slot machine. At first, an outline construction of the slot machine according to the embodiment will be described with reference to FIGS. 2 and 3. FIG. 2 is a perspective view of the slot machine. FIG. 3 is a block diagram schematically showing a control system of the slot machine.

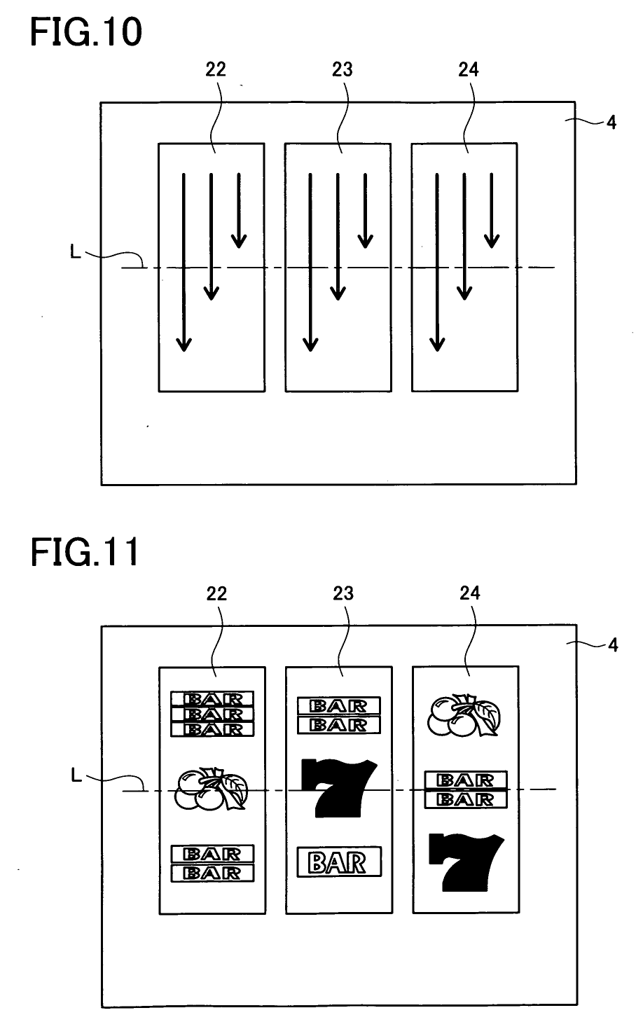

In FIG. 2, the slot machine 1 has a cabinet 2 which forms whole of the slot machine 1. At an upper position of front plane of the cabinet 2, a liquid crystal display 3 is arranged, and at a center position of the front plane of the cabinet 2, a front panel 4 is arranged. Here, the liquid crystal display 3 is constructed from a liquid crystal display which is generally used. And on the liquid crystal display 3 it is displayed information concerning with a game such as game methods, kinds of winning combinations and payouts thereof and various effects concerning with the game. And on the front panel 4, three variable display portions 22 to 24 and a pay line L are provided, and various symbols mentioned later are variably displayed in each of the variable display portions 22 to 24 while being scrolled from an upper direction to a lower direction (see FIG. 10 mentioned later). Further, on the front panel 4, it is provided a credit display portion 301 in which a credit score corresponding to coins obtained in the game by the player is displayed.

At a lower side of the front panel 4, it is provided a control table 5 which is projected toward a forward direction. On the control panel 5, a CHANGE button 6, a CASHOUT button 7 and a HELP button 8 are arranged from the most left side, and a coin insertion slot 9 and a bill insertion portion 10 are arranged at the right side of the HELP button 8. And from the left side on a forward side of the control table 5, a 1-BET button 11, a bet number determination button 12, a 3-BET button 13 and a 5-BET button 14 are arranged.

Here, the CHANGE button 6 is a button which is pressed when a bill inserted in the bill insertion portion 10 is changed into coins, and coins changed are paid out to a coin receiver 16 from a coin payout opening 15 formed at a lower position of the cabinet 2. To such CHANGE button 6, a CHANGE switch 26 mentioned later is attached, and a switch signal is output to a CPU 50 (see FIG. 3) from the CHANGE switch 62 on the basis of press of the CHANGE button 6.

The CASHOUT button 7 is a button pressed when the game is terminated, and when the CASHOUT button 7 is pressed, coins obtained in the game are paid out to the coin receiver 16 from the coin payout opening 15. Here, coins obtained in each game are generally accumulated as the credit score, thus in a case that the CASHOUT button 7 is pressed, coins equivalent to the credit score at that time are paid out. To the CASHOUT button 7, a CASHOUT switch 63 mentioned later is attached and a switch signal is output to the CPU 50 (see FIG. 3) on the basis of press of the CASHOUT button 7.

The HELP button 8 is a button which is pressed when game operation methods cannot be understood, and when the HELP button 8 is pressed, various kinds of help information are displayed on the liquid crystal display 3. To the HELP button 8, a HELP switch 64 mentioned later is attached, and a switch signal is output to the CPU 50 from the HELP switch 64 on the basis of press of the HELP button 8.

To the coin insertion slot 9, a coin sensor 65 mentioned later is attached, and when a coin is inserted in the coin insertion slot 9, a coin detection signal is output to the CPU 50 (see FIG. 3) through the coin sensor 65. Here, in a case that coins are inserted in the coin insertion slot 9, a score equivalent to coins inserted is added to the credit.

To the bill insertion portion 10, a bill sensor 66 mentioned later is attached, and when a bill is inserted in the bill insertion portion 10, a bill detection signal is output to the CPU 50 (see FIG. 3) through the bill sensor 66. Here, in a case that the CHANGE button 6 is not pressed when a bill is inserted in the bill insertion portion 10, a score equivalent to the bill inserted is added to the credit.

The 1-BET button 11 is a button every one time press of which 1 (BET) is betted. To the 1-BET button 11, a 1-BET switch 59 mentioned later is attached and when the 1-BET button 11 is pressed, a switch signal is output to the CPU 50 (see FIG. 3) from the 1-BET switch 59 on the basis of press of the 1-BET button.

The bet number determination button 12 is a button to start a game with previous bet number or present bet number on the basis of press thereof. To the bet number determination button 12, a bet number determination switch 58 mentioned later is attached, and when the bet number determination button 12 is pressed, a switch signal is output to the CPU 50 (see FIG. 3) from the bet number determination switch 58 on the basis of press of the bet number determination button 12. Here, as the bet number capable of being betted through press of the bet number determination button 12, 1, 2, 3 and 5 can be available.

The 3-BET 13 button is a button to bet 3 on the basis of press thereof. To the 3-BET button 13, a 3-BET switch 60 mentioned later is attached, and when the 3-BET button 13 is pressed, a signal is output to the CPU 50 (see FIG. 3) from the 3-BET switch 60 on the basis of press of the 3-BET button 13. And the 5-BET switch 14 is a button to bet 5 on the basis press thereof. To the 5-BET button, a 5-BET switch 61 is attached, and when the 5-BET button 14 is pressed, a signal is output to the CPU 50 (see FIG. 3) from the 5-BET switch 61 on the basis of press of the 5-BET button 14.

Here, when bet operation is conducted based on operation of the bet number determination button 12, the 1-BET button 11, the 3-BET button 13 or the 5-BET button 14, the score equivalent to the bet number is subtracted from the credit.

And to a lower side of the cabinet 2, there are formed the coin payout opening 15 and the coin receiver 16 to receive coins paid out from the coin payout opening 15. Within the coin payout opening 15 a coin detection portion 73 constructed from a sensor or the like is arranged. Such coin detection portion 73 detects a number of coins paid out from the coin payout opening 15 (see FIG. 3).

And at the most forward side on the control table 5, stop buttons 27 to 29 are provided corresponding to each of the variable display portions 22 to 24. Here, as mentioned later, although these stop buttons 27 to 29 are pressed and operated when the player wants to stop and display symbols which are variably displayed while being scrolled in the variable display portions 22 to 24 corresponding to the stop buttons 27 to 29, the symbols cannot be stopped and displayed at a timing that the stop buttons 27 to 29 are pressed and operated. The switch signal output to the CPU 50 from each of stop button switches 311 to 313 based on press operation of the stop buttons 27 to 29 is merely used to the last as a trigger when the symbols, which are variably displayed while being scrolled in the variable display portions 22 to 24, are stopped and displayed (see FIG. 3).

And at a rear side of the front panel 4, three reels 220 are rotatably supported so that each reel 220 is parallel and independently arranged with each other (see FIG. 3). And the game is conducted by using symbols of the reels 220, the symbols capable of being seen through each of the variable display portions 22 to 24 of the front panel 4.

Here, each reel 220 will be explained. Among three reels 220, the left reel 220 seen from the front plane of the slot machine 1 faces to the left variable display portion 22 formed in the front panel 4 and corresponds to the left stop button 27. The center reel 220 similarly faces to the center variable display portion 23 formed in the front panel 4 and corresponds to the center stop button 28. And the right reel 220 similarly faces to the right variable display portion 24 formed in the front panel 4 and corresponds to the right stop button 29.

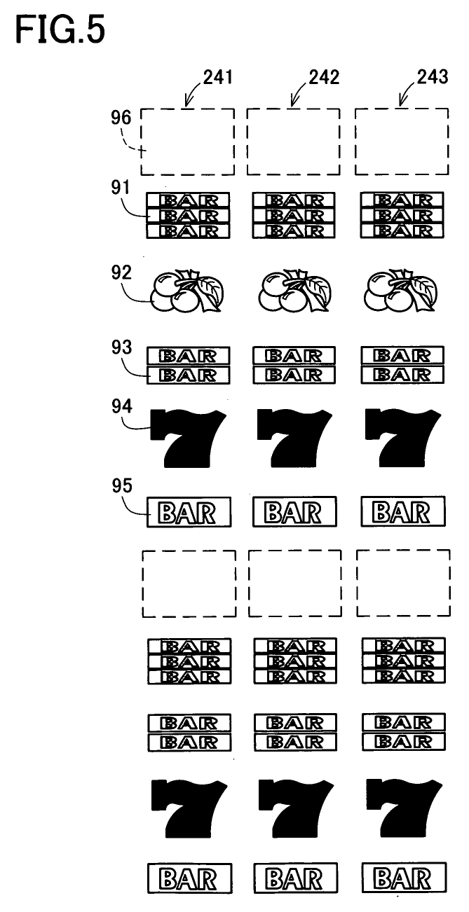

Next, with reference to FIG. 5, symbol columns, each of which is formed on the peripheral surface of each reel 220 and stopped and displayed in each of the variable display portions 22 to 24, will be described. In FIG. 5, a symbol column 241 is a symbol column which is variably displayed and stopped in the left variable display portion 22, a symbol column 242 is a symbol column which is variably displayed and stopped in the center variable display portion 25 and a symbol column 243 is a symbol column which is variably displayed and stopped in the right variable display portion 24.

Here, each of the symbol columns 241 to 243 has the same symbol arrangement and each symbol column is formed from eleven symbols by voluntarily combining a triple BAR 91, a cherry 92, a double BAR 93, a seven 94, a single BAR 95 and a blank 96 (area with no symbol).

Here, in a case that each of the symbol columns 241 to 243, which are variably displayed while being scrolled in each of the variable display portions 22 to 24, is stopped and displayed, three symbols are stopped and displayed in each of the variable display portions (see FIG. 11 mentioned later).

And various winning combinations are preset based on plural kinds of combinations of symbols, and when a symbol combination corresponding to the winning combination is stopped on the pay line L, the score equivalent to the number of coins corresponding to the winning combination is added to the credit, as similarly in the conventional slot machine. Therefore, explanation thereof will be omitted.

And when various symbols are formed on the peripheral surface of each reel 220, it is general that eleven symbols are printed on a long reel sheet a width and length of which equal to those of each reel 220, and such reel sheet is adhered onto the peripheral surface of each reel 220. Of course, a method other than the above method may be used to form symbols on each reel 220.

Next, a control system of the slot machine 1 will be described with reference to FIG. 3. FIG. 3 is a block diagram schematically showing a control system of the slot machine.

In FIG. 3, the control system of the slot machine 1 is basically constructed from the CPU 50 which is a main device. To the CPU 50, a ROM 51 and a RAM 52 are connected. In the ROM 51, there are stored a main process program mentioned later, a lottery and stop control process program, various effect programs to conduct various effects on the liquid crystal display 3 according to progress of the game, a lottery table for conducting a lottery of stop display symbols of the game, the other various programs necessary for control of the slot machine 1 and data tables. And the RAM 52 is a memory to temporarily store various data calculated by the CPU 50. For example, the score of credit is stored in the RAM 52.

And to the CPU 50, a clock pulse generation circuit 53 for generating standard clock pulses and a frequency divider 54 are connected, and a random number generator 55 for generating random numbers and a random number sampling circuit 56 are connected. The random number sampled through the random number sampling circuit 56 is utilized in various lotteries such as winning combinations and the like. Further, to the CPU 50, there are respectively connected a bet number determination switch 58 attached to the bet number determination button 12, a 1-BET switch 59 attached to the 1-BET button 11, a 3-BET switch 60 attached to the 3-BET button 13, a 5-BET switch 61 attached to the 5-BET button 14, a CHANGE switch 62 attached to the CHANGE button 6, a CASHOUT switch 63 attached to the CASHOUT button 7 and a HELP switch 64 attached to the HELP button 8. The CPU 50 conducts control to execute various processes corresponding to the buttons, based on the switch signal output from each of the switches according to press of each button.

To the CPU 50, three stepping motors 68 which conduct rotation of each of the reels 220 through a motor drive circuit 167 are connected, and a position change detection circuit 69 is connected. When a motor drive signal (instruction pulse) is output to the motor drive circuit 167 from the CPU 50, the stepping motors 68 are driven and rotated by excitation signals output from the motor drive circuit 167. Thereby, each of the reels 220 is rotated.

At that time, the CPU 50 counts a drive pulse number supplied to each stepping motor 68, and the CPU 50 calculates a rotation position of each symbol in each reel 220 based on the drive pulse number counted, and conducts stop position control of the reels 220.

To the CPU 50, the position change detection circuit 69 is connected. The position change detection circuit 69 detects change of stop position of the reel 220 after the reel 220 is controlled so as to stop through the motor drive circuit 167.

Further, to the CPU 50, there are respectively connected a coin sensor 65 arranged within the coin insertion slot 9 and a bill sensor 66 arranged in the bill insertion portion 10. The coin sensor 65 detects coins inserted from the coin insertion slot 9 and the CPU 50 calculates a number of coins inserted based on a coin detection signal output from the coin sensor 65. The bill sensor 66 detects the kind and sum of bill inserted in the bill insertion portion 10 and the CPU 50 calculates a number of coins equivalent to the sum of bill based on a bill detection signal output from the bill sensor 66.

Further, to the CPU 50, stop switches 311 to 313 respectively attached to the stop buttons 27 to 29 are connected. Here, when press operation of the left stop button 27 is conducted, the switch signal is output from the left stop button switch 311, and based on such switch signal the CPU 50 conducts stop display of symbols which are variably displayed in the left variable display portion 22 while being scrolled. And when press operation of the center stop button 28 is conducted, the switch signal is output from the center stop button switch 312, and based on such switch signal the CPU 50 conducts stop display of symbols which are variably displayed in the center variable display portion 23 while being scrolled. Further, when press operation of the right stop button 29 is conducted, the switch signal is output from the right stop button switch 313, and based on such switch signal the CPU 50 conducts stop display of symbols which are variably displayed in the right variable display portion 24 while being scrolled.

To the CPU 50, a hopper 71 is connected through a hopper drive circuit 70. When a drive signal is output to the hopper drive circuit 70 from the CPU 50, the hopper 71 pays out a predetermined number of coins from the coin payout opening 15.

And to the CPU 50, a coin detection portion 73 is connected through a payout completion signal circuit 72. The coin detection portion 73 is arranged within the coin payout opening 15, and if the coin detection portions 73 detects that a predetermined number of coins are paid out, a coin payout completion signal is output to the payout completion signal circuit 72 from the coin detection portion 73. Based on this, payout completion signal circuit 72 outputs a payout completion signal to the CPU 50. Further, to the CPU 50, the liquid crystal display 73 is connected through a liquid crystal drive circuit 74 and the liquid crystal display 3 is controlled by the CPU 50.

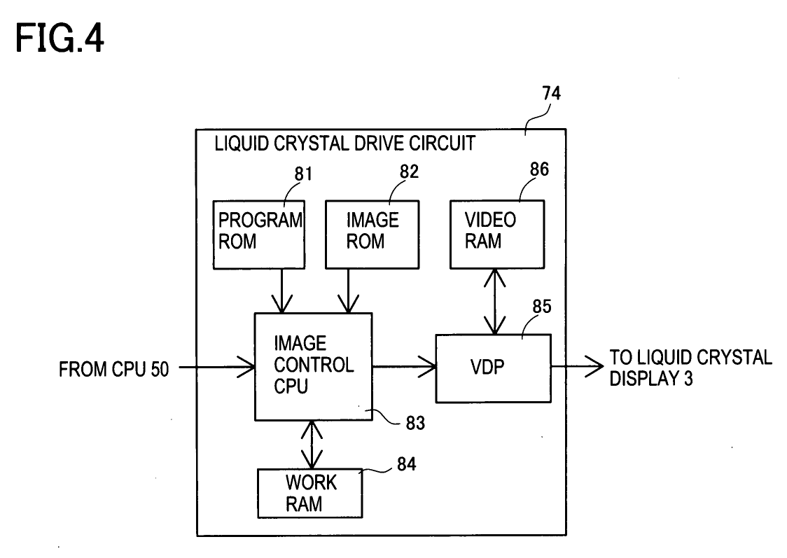

Here, as shown in FIG. 4, the liquid crystal drive circuit 74 is constructed from a program ROM 81, an image ROM 82, an image control CPU 83, a work RAM 84, a VDP (Video Display Processor) 85 and a video RAM 86. And in the program ROM 81, an image control program concerning with display on the liquid crystal display 3 and various selection tables are stored. And in the image ROM 82, for example, dot data to form images displayed on the liquid crystal display 3 are stored. Further, the image control CPU 83 determines images displayed on the liquid crystal display 3 among dot data stored beforehand in the image ROM 82, according to the image control program stored beforehand in the program ROM 61, based on the parameters set by the CPU 50. And the work RAM 84 is constructed as a temporary memory when the image control program is executed by the image control CPU 83. Further, the VDP 85 forms images corresponding to display contents determined by the image control CPU 83 and outputs those to the liquid crystal display 3. Here, the video RAM 86 is constructed as a temporary memory when images are formed by the VDP 85.

Returning to FIG. 3, to the CPU 50, a credit display portion 301 is connected through a credit display circuit 302, thereby the score of credit corresponding to coins obtained by the player in the game and accumulated is displayed in the credit display portion 301.

And to the CPU 50, LEDs 78 are connected through a LED drive circuit 77. Many LEDs 78 are arranged on the front plane of the slot machine 1 and are controlled so as to turn on or off through the LED drive circuit 77 based on the drive signal from the CPU 50, when various effects are conducted. Further, a speaker 80 is connected to the CPU 50 through a sound output circuit 79 and the speaker 80 outputs various effect sounds when various effects are conducted based on the output signal from the sound output circuit 79.

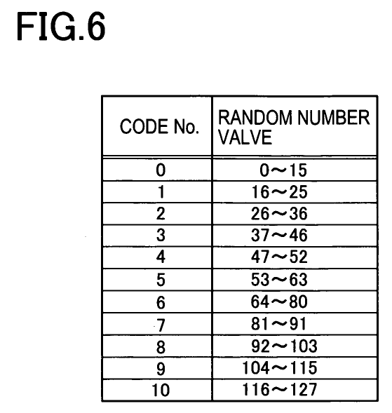

Here, it will be described with reference to FIG. 6 a lottery table which is used when symbols stopped and displayed on the pay line L are determined in a case that the game is conducted by using three variable display portions 22 to 24 in the slot machine 1. FIG. 6 is an explanatory view showing a lottery table of stop display symbols in a case that the game is conducted by three variable display portions.

Here, symbols stopped and displayed on the pay line L are determined every each of the variable display portions 22 to 24. In order to realize this, code Nos. of “0 ” “10” are allotted from the uppermost position in order to each of the symbol columns 241 to 243 respectively corresponding to each of the variable display portions 22 to 24 shown in FIG. 5. And the lottery table shown in FIG. 6 is prepared beforehand. And three random numbers are sampled through the random number sampling circuit 56 so as to correspond to each of the variable display portions 22 to 24.

Hereinafter, for convenience' sake, the symbol column 241 of the left variable display portion 22 is described as “left reel”, the symbol column 242 of the center variable display portions 23 is described as “center reel” and the symbol column 243 of the right variable display portion 24 is described as “right reel”.

Here, as for the “left reel” of the symbol column 241 corresponding to the left variable display portion 22, as shown in the lottery table of FIG. 6, if the random number value sampled through the random number sampling circuit 56 lies in a range of 0˜15, the blank 96 allotted to the code No. “0” is stopped and displayed on the pay line L. As for each of the code Nos. “1” ˜“10”, similarly to the above, symbol determination is conducted based on the lottery table shown in FIG. 6

Here, the “center reel” of the symbol column 242 corresponding to the center variable display portions 23 and the “right reel” of the symbol column 243 corresponding to the right variable display portion 24 are similarly handled to the “left reel” of the symbol column 242 corresponding to the left variable display portion 22.

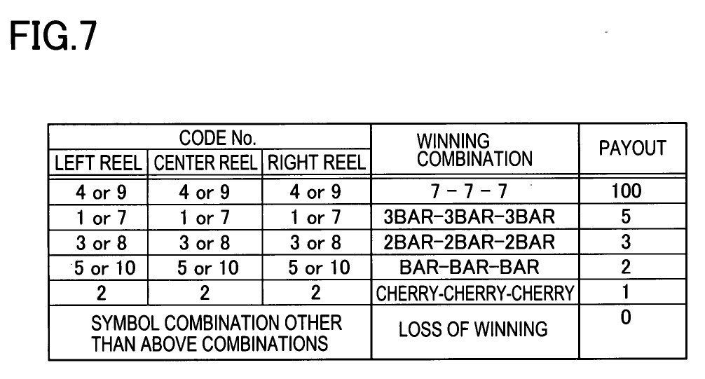

Next, it will be described with reference to FIG. 7 winning combinations and payouts thereof in a case that the game is conducted by using three variable display portions 22 to 24 in the slot machine 1. FIG. 7 is an explanatory view showing winning combinations and payouts thereof in a case that the game is conducted by using three variable display portions in the slot machine 1. In FIG. 7, if all of the code Nos. of the “left reel”, the “center reel” and the “right reel” are “4” or “9”, the winning combination “7-7-7” will won. In this case, in each of the variable display portions 22 to 24, the seven 94 is stopped and displayed on the pay line L and the payout of “100” is obtained. As for each of the payouts of “5”, “3”, “2” and “1”, such payout is similarly determined based on the table shown in FIG. 7.

Here, if the code Nos. of the “left reel”, the “center reel” and the “right reel” become combinations other than the combinations mentioned in the above, the game is lost (“loss”). In this case, although any one of the triple BAR 91, the cherry 92, the double BAR 93, the seven 94, the single BAR 95 and the blank 96 corresponding to the code No. is stopped and displayed on the pay line L in each of the variable display portions 22 to 24, no payout is given.

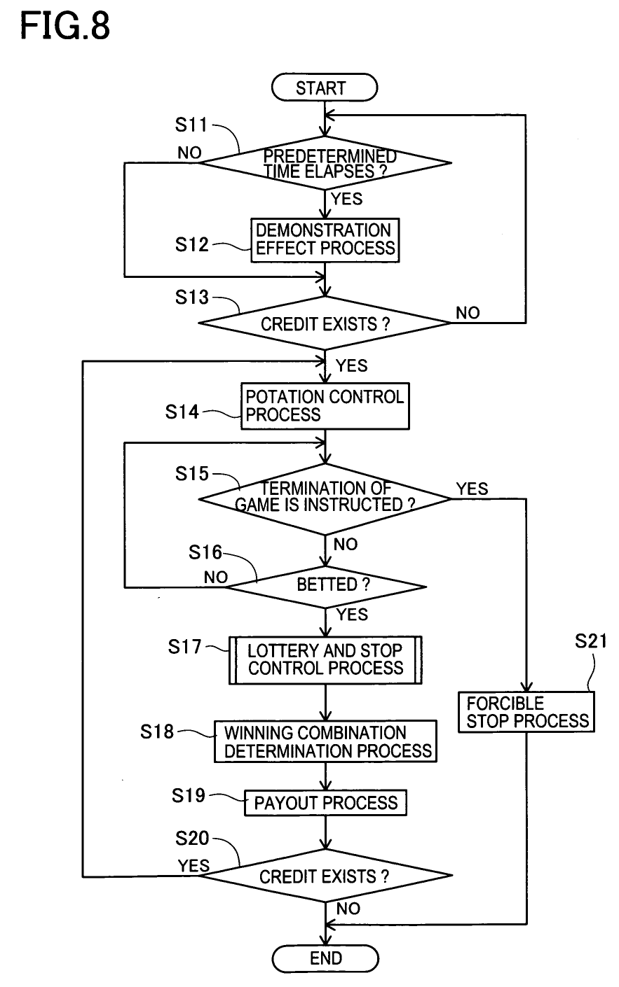

Next, with reference to FIG. 8, the main process program executed in the slot machine 1 will be described. FIG. 8 is a flowchart of the main process program. In FIG. 8, at first, in step (abbreviated as “S”) 11, it is determined whether or not a predetermined time (for example, 15 seconds) elapses. If it is determined that the predetermined time does not elapse (S11: NO), procedure shifts to S13. On the contrary, if it is determined that the predetermined time elapses (S11: YES), the demonstration effect is conducted on the liquid crystal display 3 in S12, thereafter procedure shifts to S13.

In S13, it is determined whether or not the score of credit exists. If it is determined that the score of credit does not exist (S13: NO), procedure returns to S11 and procedures mentioned in the above are repeated. On the other hand, if it is determined that the score of credit exists (S13: YES), procedure shifts to S14 even if such demonstration effect is conducted.

In S14, all of reels 220 are started to rotate. At that time, on the front panel 4 as shown in FIG. 10, various symbols are variably displayed in each of the variable display portions 22 to 24 while being scrolled from the upper direction toward the lower direction.

And in S15, it is determined whether or not a termination instruction is done by the player. This determination is concretely conducted based on whether or not press operation of the CASHOUT button 7 is done. If it is determined that the termination instruction is done by the player (S15: YES), procedure shifts to S21 mentioned later. On the other hand, if it is determined that the termination instruction is not done by the player (S15: NO), procedure shifts to S16.

In S16, it is determined whether or not bet operation is conducted by the player. This determination is concretely done based on whether or not the bet number set by press operation of the 1-BET button 11, the 3-BET button 13 or the 5-BET button 14 is determined as the bet number of this time by press operation of the bet number determination button 12. Here, if the bet number of this time is as same as the bet number of previous time, the bet number may be determined only by press operation of the bet number determination button 12, without press operation of the 1-BET button 11, the 3-BET button 13 or the 5-BET button 14. If it is determined that bet operation is not done by the player (S16: NO), procedure returns to S15 and procedures mentioned in the above are repeated. On the contrary, if it is determined that bet operation is done by the player (S16: YES), procedure shifts to S17.

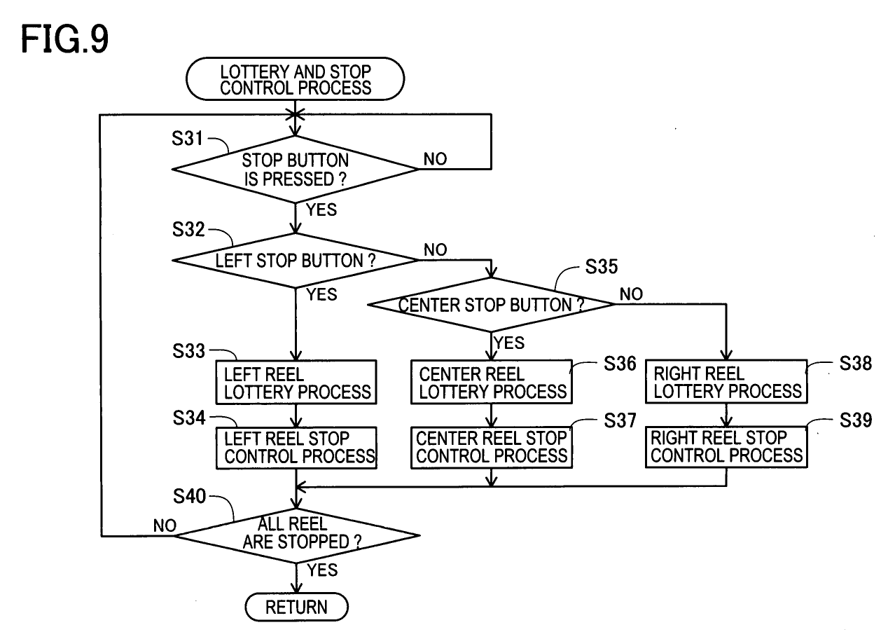

In S17, the lottery and stop control process is conducted. Here, the lottery and stop control process program will be described with reference to FIG. 9. FIG. 9 is a flowchart of the lottery and stop control process program.

In FIG. 9, at first, in S31, it is determined whether or not press operation of any one of the stop buttons 27 to 29 is conducted by the player. If it is determined that none of the stop buttons 27 to 29 is pressed (S31: NO), procedure returns to S31 and waits till press operation of any one of the stop buttons 27 to 29 is conducted. On the other hand, if it is determined that press operation of any one of the stop buttons 27 to 29 is conducted (S31: YES), procedure shifts to S32.

In S32, it is determined whether or not the stop button pressed by the player is the left stop button 27. If it is determined that the stop button pressed by the player is not the left stop button 27 (S32: NO), procedure shifts to S35 mentioned later. On the contrary, if it is determined that the stop button pressed by the player is the left stop button (S32: YES) procedure shifts to S33.

In S33, a left lottery process is conducted. In order to execute this process, a symbol determination process is done and the symbol stopped and displayed on the pay line L in the left variable display portion 22 is determined. Concretely, as mentioned in the above, one random number corresponding to the left variable display portion 22 is sampled through the random number sampling circuit 56 and the symbol stopped and displayed is determined by using the code No. based on the lottery table shown in FIG. 6. And after the symbol stopped and displayed on the pay line L is determined, procedure shifts to S34.

Here, after the left lottery process is conducted, it is conducted the effect so that the liquid crystal display 3 or the LEDs 78 are flashed and the effect sounds are output from the speaker 80.

And in S34, the left stop control process is conducted and the reel 220 corresponding to the left variable display portions 22 is stopped to rotate so that the symbol determined in S33 is stopped and displayed on the pay line L. Hereafter, press operation of the left stop button 27 is invalidated till a new lottery and stop control process is done.

On the other hand, in S32, if it is determined that the stop button pressed by the player is not the left stop button 27 (S32: NO), procedure shifts to S35.

In S35, it is determined whether or not the stop button pressed by the player is the center stop button 28. If it is determined that the stop button pressed by the player is not the center stop button 28 (S35: NO), procedure shifts to S38 mentioned later. On the other hand, if it is determined that the stop button pressed by the player is the center stop button 28 ((S35: YES), procedure shifts to S36.

In S36, the center lottery process is conducted. In order to execute this process, a symbol determination process is done and the symbol stopped and displayed on the pay line L in the center variable display portion 23 is determined. Concretely, as mentioned in the above, one random number corresponding to the center variable display portion 23 is sampled through the random number sampling circuit 56 and the symbol stopped and displayed is determined by using the code No. based on the lottery table shown in FIG. 6. And after the symbol stopped and displayed on the pay line L is determined, procedure shifts to S37.

Here, after the center lottery process is conducted, it is conducted the effect so that the liquid crystal display 3 or the LEDs 78 are flashed and the effect sounds are output from the speaker 80.

And in S37, the center stop control process is conducted and the reel 220 corresponding to the center variable display portions 23 is stopped to rotate so that the symbol determined in S36 is stopped and displayed on the pay line L. Hereafter, press operation of the center stop button 28 is invalidated till a new lottery and stop control process is done.

On the other hand, in S35, if it is determined that the stop button pressed by the player is not the center stop button 28 (S35: NO), procedure shifts to S38.

In S38, the right lottery process is conducted. In order to execute this process, a symbol determination process is done and the symbol stopped and displayed on the pay line L in the right variable display portion 24 is determined. Concretely, as mentioned in the above, one random number corresponding to the right variable display portion 24 is sampled through the random number sampling circuit 56 and the symbol stopped and displayed is determined by using the code No. based on the lottery table shown in FIG. 6. And after the symbol stopped and displayed on the pay line L is determined, procedure shifts to S39.

Here, after the right lottery process is conducted, it is conducted the effect so that the liquid crystal display 3 or the LEDs 78 are flashed and the effect sounds are output from the speaker 80.

And in S39, the right stop control process is conducted and the reel 220 corresponding to the right variable display portions 24 is stopped to rotate so that the symbol determined in S38 is stopped and displayed on the pay line L. Hereafter, press operation of the right stop button 29 is invalidated till a new lottery and stop control process is done.

Here, in the embodiment, the stop buttons 27 to 29 have no relation with, so-called, “press operation of target symbol while seeing” which is done to permit technical intervention by the player, and each of the signals output from the stop buttons 27 to 29 merely becomes a trigger when the symbols of each reel 220 (each of variable display portions 22 to 24) variably displayed are stopped and displayed. Therefore, the symbols of each reel 220 (each of the variable display portions 22 to 24) are stopped and displayed based on a lottery result determined in S33, S36, S38. In other words, press operation of the stop buttons 27 to 29 merely becomes a trigger to start execution of the effect (the effect as if the reel 220 is stopped corresponding to press operation of the stop buttons 27 to 29 by the player) conducted till the stop symbol determined by the lottery result is stopped.

And after the process of any of S34, S37 and S39 is executed, procedure shifts to S40 and it is determined whether or not rotation of all reels 220 is stopped. If it is determined that rotation of all reels 220 is not stopped (S40: NO), procedure returns to S31 and the processes mentioned in the above are repeated. On the other hand, if it is determined that rotation of all reels 220 is stopped (S40: YES), procedure returns to S18 of FIG. 8 after the lottery and stop control process program is terminated.

Here, if it is determined that rotation of all reels 220 is stopped, as shown in FIG. 11, on the front panel 4, each of the symbol columns 241 to 243, which are variably displayed while being scrolled in each of the variable display portions 22 to 24, is stopped and displayed, thereby three symbols are stopped and displayed in each variable display portion.

And in S18, the winning combination determination process is conducted. Concretely speaking, as mentioned in the above, the winning combination and the payout thereof are determined based on the table in FIG. 7, through the code No. obtained in each of S33, S36, S38.

Further, after procedure shifts to S19, coins corresponding to the payout preset beforehand are paid out based on the table in FIG. 7, according to the symbol combination corresponding to the winning combination stopped and displayed on the pay line L in each of the variable display portions 22 to 24. Here, in this case, coins obtained in the game are paid out by a method that the score corresponding to the number of coins is added to the credit.

And in S20, it is determined whether or not the score of credit exists. If it is determined that the score of credit exists (S20: YES), procedure returns to S14 and after rotation of three reels 220 is started, the processes following to S15 are repeated. On the other hand, if it is determined that the score of credit does not exist (S20: NO), the main process program is terminated.

Here, in S15, if it is determined that the termination instruction is conducted by the player (S15: YES), procedure shifts to S21 and after rotation of all reels 220 is stopped, the main process program is terminated.

Therefore, the CPU 50 functions as “lottery device” when executing any process of S33, S36, S38 in FIG. 9.

And the CPU 50 functions as “variable display control device” when executing the process in S14 shown in FIG. 8. Thus, “after termination of the game” means right after the process in S19 (payout of coins and addition of credit) is executed.

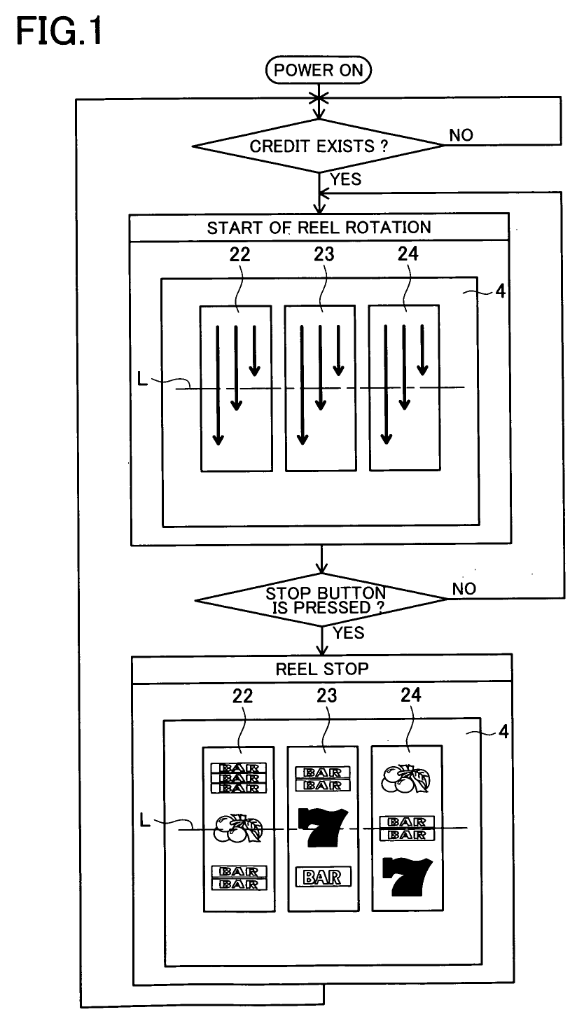

As mentioned above in detail, in the slot machine 1 of the embodiment, as shown in FIG. 1, if the score of credit occurs after electric power is turned on, rotation of all reels 220 is started and various symbols are variably displayed in each of the variable display portions 22 to 24 while being scrolled from the upper direction toward the lower direction. Thereafter, if press operation of the stop buttons 27 to 29, is conducted the reel corresponding to the stop button pressed is stopped to rotate, thereby three symbols are stopped and displayed in each of the variable display portions 22 to 24. And if the score of credit still exists when three symbols are stopped and displayed in each of the variable display portions 22 to 24, all reels 220 are again started to rotate.

That is to say, in the slot machine 1 of the embodiment, as shown in FIGS. 8 and 9, if it is determined that the score of credit exists (S13: YES) and the game is started, it is conducted the lottery (S33, S36, S38) to determine the symbol stopped and displayed on the pay line L in each of the variable display portions 22 to 24 by using the instruction from the player as the trigger (S31: YES), the instruction being accepted through press operation of the stop buttons 27 to 29, only while various symbols are variably displayed in each of the variable display portions 22 to 24 while being scrolled from the upper direction toward the lower direction. Further, rotation of three reels 220 corresponding to each of the variable display portions 22 to 24 is stopped (S34, S37, S39) so that the symbols determined in such lottery are stopped and displayed on the pay line L. And according to the symbol combination corresponding to the winning combination stopped and displayed on the pay line L in the variable display portions 22 to 24, coins corresponding to the payout preset are paid out (S19) based on the table in FIG. 7, thereafter the game is terminated.

Thereafter, if it is determined that the score of credit exists (S20: YES), rotation of all reels 220 is automatically started (S14) even if the instruction from the player is not output, thereby when a new game is started thereafter, the slot machine 1 is in a state that various symbols are variably displayed in each of the variable display portions 22 to 24 while being scrolled from the upper direction toward the lower direction. Therefore, rotation operation of the reels 229 can be omitted between games, thereby the gaming time can be reduced for the slot game in which coins are paid out according to the symbol combination corresponding to the winning combination which is determined based on the result in the lottery conducted by using the player's instruction as the trigger and is stopped and displayed on the pay line L in each of the variable display portions 22 to 24.

Here, the present invention is not limited to the above embodiment and various changes or modifications may be done within the scope of the present invention.

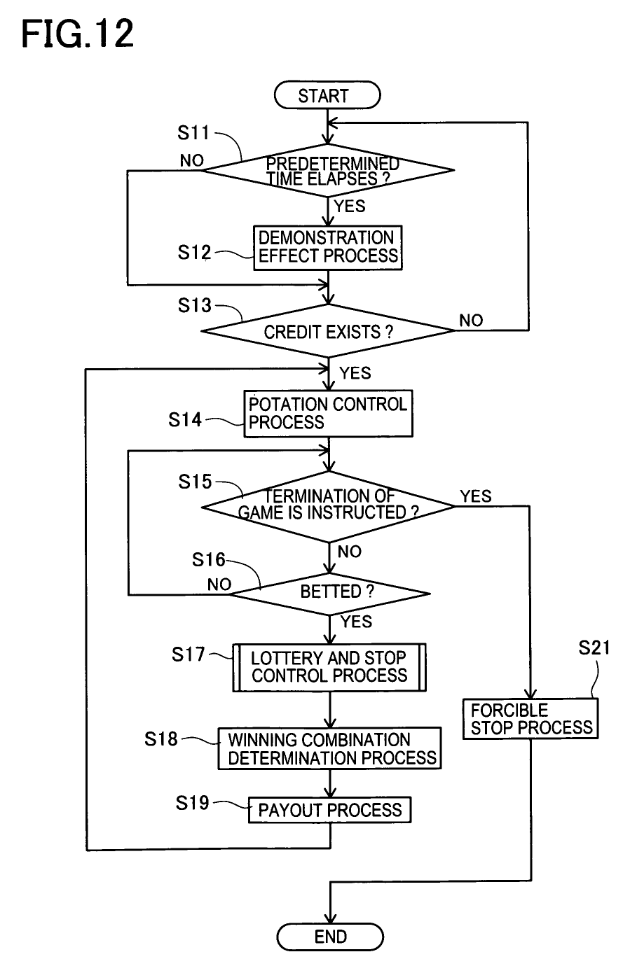

For example, in the slot machine 1 of the embodiment, as shown in FIG. 8, the game is terminated after the payout process is conducted (S19), and at that time, if it is determined that the score of credit exists (S20: YES), rotation of all reels 220 is automatically started (S14). Thereby, when a new game is started thereafter, the slot machine 1 is in a state that various symbols are variably displayed in each of the variable display portions 22 to 24 while being scrolled from the upper direction toward the lower direction. At this point, as shown in FIG. 12, if the payout process is conducted (S19) and the game is terminated, rotation of all reels 200 is always automatically started (S14) at that time, with no relation to whether or not the score of credit exists.

And in the slot machine 1 of the embodiment, as shown in FIG. 9, the lottery to determine the symbol stopped and displayed on the pay line L in each of the variable display portions 22 to 24 is individually conducted at the timing of press operation of each of the stop buttons 27 to 29 (S33, S36, S38). At this point, the lottery to determine the symbols stopped and displayed on the pay line L in each of the variable display portions 22 to 24 may be conducted at a time at a timing that any of the stop buttons 27 to 29 is first pressed or that the bet number determination button 12 is pressed.

Here, in a case that the lottery to determine the symbols stopped and displayed on the pay line in each of the variable display portions 22 to 24 is conducted at a time, the stop buttons 27 to 29 may be substitutable for only one stop button.

And in the above embodiment, there will exist a characteristic construction in a point that the conventional spin button is substituted as the stop button used when the reels are stopped.

And also in the modification (lottery to determine the symbols stopped and displayed on the pay line L in each of the variable display portions 22 to 24 is conducted at a time at the timing that the bet number determination button 12 is pressed), there will exist a characteristic construction in a point that the bet number determination button 12 is substituted as the stop button used when the reels are stopped.

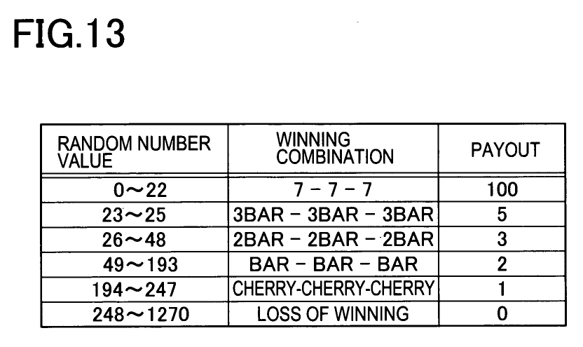

Further, in the slot machine 1 of the embodiment, as shown in FIGS. 6 and 7, although the symbol stopped and displayed on the pay line L is determined every each of the variable display portions 22 to 24 based on the random number value sampled through the random number sampling circuit 56, all symbols stopped and displayed on the pay line L in each of the variable display portions 22 to 24 may be determined based on the random number value sampled through the random number sampling circuit 56. In order to realize this, a lottery table of winning combinations shown in FIG. 13 is utilized. FIG. 13 is an explanatory view showing a lottery table of winning combinations and payouts thereof.

In FIG. 13, a random number range used in the lottery table of winning combinations lies in 0˜1270. If the random number value sampled through the random number sampling circuit 56 lies in a range of 0˜22, the winning combination “7-7-7” is won and the payout of “100” can be obtained. As for each of the payouts of “5”, “3”, “2” and “1”, such payout is similarly determined based on the table shown in FIG. 13.

Here, if the random number value lies in a range of 248˜1270, the game is lost (“loss”). In this case, although the symbol combination other than the winning combinations mentioned in the above is stopped and displayed on the pay line L, no payout is given.

And the lottery conducted by using the lottery table of winning combinations shown in FIG. 13 is done at a timing that any of the stop buttons 27 to 29 is first pressed or that the bet number determination button 12 is pressed.

Here, as mentioned in the above, if the lottery to determine the symbols stopped and displayed on the pay line L in each of the variable display portions 22 to 24 is conducted at a time, the stop buttons 27 to 29 can be substituted for only one stop button.

And in the slot machine of the embodiment, although the variable display and stop display of the symbols done in each of the variable display portions 22 to 24 is conducted by rotation of the reels 220, the video reels may be utilized.

And in the slot machine 1 of the embodiment, although only the base game is conducted, the free game may be conducted after the base game is conducted, for example, right after the process of S19 in FIG. 8 or FIG. 12. Here, in the free game, games beneficial for the player are generally conducted in many cases. For example, when the game shifts to the free game under a condition that a specific symbol is stopped and displayed, 10 games, 20 games or 30 games are continuously conducted corresponding to the rank of free game, without betting coins. At that time, in the free game, it is general that a winning probability to win various winning combinations is set high, thus the player can obtain many coins in many cases.

The present invention can be adopted for a gaming machine having display technique to conduct variable display and stop display of the symbols.

What is claimed is:

1. A gaming machine comprising:
a display device for variable displaying a plurality of symbols;
an operation device for allowing a player to input an instruction;
a processor programmed to operate with the display device and the operation device to (a) automatically start a variable display of the symbols on the display device after a game is terminated, (b) enable the player to input the instruction by the operation device during the variable display of the symbols, (c) determine the symbols for a stop display on the display device based on the instruction, and (d) display the symbols determined on the display device.

2. The gaming machine according to claim 1, wherein the processor determines whether or not a credit exists after the game is terminated and automatically starts the variable display of the symbols if the credit exists after the game is terminated.

3. The gaming machine according to claim 1, wherein the processor determines whether or not an award is provided and automatically starts the variable display of the symbols if the award is provided.

4. The gaming machine according to claim 1, further comprising:
a plurality of symbol columns each of which includes plural kinds of symbols;
wherein the operation device includes a plurality of operation buttons each of which corresponds to each of the symbol columns, and
wherein the processor determines the symbol included in one symbol column every one operation button corresponding to the one symbol column is operated.

5. The gaming machine according to claim 4, wherein after the symbol in the one symbol column determined by the processor is stopped and displayed on the display device, the one operation button corresponding to the one symbol column including the symbol stopped and displayed is invalidated till the symbol included in another symbol column is stopped and displayed on the display device.

6. A gaming machine comprising:
a display device for variable displaying a plurality of symbols;
an operation device for allowing a player to input an instruction;
a processor programmed to operate with the display device and the operation device to (a) automatically start a variable display of the symbols on the display device after a game is terminated, (b) enable the player to input the instruction by the operation device during the variable display of the symbols, (c) determine the symbols for a stop display on the display device based on the instruction, and (d) display the symbols determined on the display device;
wherein the processor determines whether or not a credit exists after the game is terminated and automatically starts the variable display of the symbols if the credit exists after the game is terminated.

7. A gaming machine comprising:
a display device for variable displaying a plurality of symbols;
an operation device for allowing a player to make a bet;
a processor programmed to operate with the display device and the operation device to (a) automatically start a variable display of the symbols on the display device, (b) enable the player to make a bet by the operation device during the variable display of the symbols, (c) determine the symbols for a stop display on the display device based on the bet, and (d) display the symbols determined on the display device.
